(19) United States
(12) Patent Application Publication
(10) Pub. No.: US 2026/0147670 A1
(43) Pub. Date: May 28, 2026

(54) METHOD OF CONTROLLING OPERATION OF MEMORY DEVICE

(71) Applicant: Samsung Electronics Co., Ltd., Suwon-si (KR)

(72) Inventors: Minuk Kim, Suwon-si (KR); Yongjune Kim, Pohang-si (KR); Seongjoon Park, Pohang-si (KR); Taewoo Park, Pohang-si (KR)

(73) Assignee: POSTECH RESEARCH AND BUSINESS DEVELOPMENT FOUNDATION, Pohang-si (KR)

(21) Appl. No.: 19/231,389

(22) Filed: Jun. 6, 2025

(30) Foreign Application Priority Data
Nov. 22, 2024 (KR) 10-2024-0168754

(51) Int. Cl. G06F 11/10

(52) U.S. Cl. CPC G06F 11/1068; G06F 11/1012; G06F 11/1048

(57) ABSTRACT

An example method of controlling an operation of a memory device comprises dividing an overall generation matrix for an arbitrary error correction code into a temporary error correction generation matrix and a shaping generation matrix, converting a temporary error correction message vector into a temporary codeword using the temporary error correction generation matrix, producing an additional codeword comprising a bit inverting at least one of bit values of the temporary codeword, producing a shaping parity vector from the shaping generation matrix and the additional codeword, performing an XOR operation on the temporary error correction message vector and the shaping parity vector to generate an overall message vector, converting the overall message vector into an overall codeword using the overall generation matrix, and writing the overall codeword into the memory device.

### CROSS-REFERENCE TO RELATED APPLICATION

This application claims priority to Korean Patent Application No. 10-2024-0168754 filed on Nov. 22, 2024, in the Korean Intellectual Property Office, the disclosure of which is incorporated herein by reference in its entirety.

### BACKGROUND

Memory devices for storing data may be generally divided into volatile memory devices and non-volatile memory devices. Volatile memory devices such as DRAM (Dynamic Random-Access Memory) maintain stored data while being energized, but the stored data is lost when de-energized. Non-volatile memory devices may store data even when de-energized.

A memory capacity may be increased by storing multiple bits in one memory cell. A memory cell may have a threshold voltage corresponding to one of multiple write states. The number and levels of a voltage for write operations and read operations may be reduced through state shaping that removes some of a plurality of write states. As a result, deterioration of the memory cell may be reduced.

### SUMMARY

When error correction code (ECC) encoding is performed after state shaping, a problem may occur in which ECC parity bits are not state-shaped.

The present disclosure relates to a method of controlling an operation of a memory device which may improve efficiency of state shaping by dividing columns of an overall generation matrix for an arbitrary error correction code, state-shaping ECC parity bits as well, and state-shaping each of a plurality of pages based on a write state of the plurality of pages.

In some implementations, a method of controlling an operation of a memory device comprises dividing an overall generation matrix for an arbitrary error correction code into a temporary error correction generation matrix and a shaping generation matrix, converting a temporary error correction message vector into a temporary codeword using the temporary error correction generation matrix, producing an additional codeword comprising a bit inverting at least one of bit values of the temporary codeword, producing a shaping parity vector from the shaping generation matrix and the additional codeword, performing an XOR operation on the temporary error correction message vector and the shaping parity vector to generate an overall message vector, converting the overall message vector into an overall codeword using the overall generation matrix, and writing the overall codeword into the memory device.

In some implementations, a method of controlling an operation of a memory device comprises dividing an overall generation matrix into a temporary error correction generation matrix and a shaping generation matrix for each of a plurality of pages, converting a temporary error correction message vector into a temporary codeword using the temporary error correction generation matrix in each of the plurality of pages, producing an additional codeword for each of the plurality of pages converting at least one object write state among a plurality of write states of the plurality of pages into at least one target write state, producing a shaping parity vector from the shaping generation matrix and the additional codeword in each of the plurality of pages, performing an XOR operation on the temporary error correction message vector and the shaping parity vector to generate an overall message vector in each of the plurality of pages, converting the overall message vector into an overall codeword using the overall generation matrix in each of the plurality of pages, and writing the overall codeword into each of the plurality of pages.

In some implementations, a method of controlling an operation of a memory device comprises dividing some columns of an overall generation matrix into a temporary error correction generation matrix and dividing the remaining columns of the overall generation matrix into a shaping generation matrix, converting a temporary error correction message vector into a temporary codeword using the temporary error correction generation matrix, producing an additional codeword comprising a bit inverting at least one of bit values of the temporary codeword, producing a shaping parity vector from the shaping generation matrix and the additional codeword, performing an XOR operation on the temporary error correction message vector and the shaping parity vector to generate an overall message vector, and converting the overall message vector into an overall codeword using the overall generation matrix, wherein at least one column of the shaping generation matrix is arranged between columns of the temporary error correction generation matrix, and the temporary error correction message vector and the shaping parity vector of the overall message vector are rearranged according to a column arrangement of the temporary error correction generation matrix and the shaping generation matrix of the overall generation matrix.

### BRIEF DESCRIPTION OF THE DRAWINGS

The above and other aspects, features, and advantages of the present disclosure will be more clearly understood from the following detailed description, taken in conjunction with the accompanying drawings.

FIG. 1 is a block diagram schematically illustrating an example of a memory system.

FIG. 2 is a block diagram schematically illustrating an example of a memory device.

FIG. 3 is a diagram illustrating an example of a 3D V-NAND structure that may be applied to a memory system.

FIG. 4 is a block diagram schematically illustrating an example of a data converter and a memory device.

FIG. 5 is a flow diagram illustrating an example of a process of controlling an operation of a memory device.

FIG. 6 is a diagram provided to explain an example of an overall generation matrix.

FIG. 7 is a diagram illustrating example write states of a multi-level cell to which a method of controlling an operation of a memory device may be applied.

FIG. 8 is a flow diagram illustrating an example of a process of controlling an operation of a memory device.

FIG. 9 is a diagram provided to explain an example of a method of controlling an operation of a memory device.

FIG. 10 is a diagram illustrating example write states of a multi-level cell to which a method of controlling an operation of a memory device may be applied.

FIG. 11 is a diagram illustrating an example of a memory device.

FIG. 12 is a diagram illustrating an example of a system to which a memory system is applied.

### DETAILED DESCRIPTION

Hereinafter, example implementations of the present disclosure will be described with reference to the accompanying drawings.

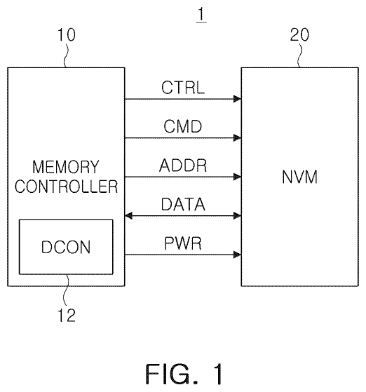

FIG. 1 is a block diagram schematically illustrating an example of a memory system.

Referring to FIG. 1, the memory system 1 may include a memory controller 10 and at least one memory device 20. The memory system 1 may include a data storage medium based on flash memory, such as a memory card, a USB memory and an SSD.

The memory device 20 of the implementation illustrated in FIG. 1 may be a nonvolatile memory device capable of maintaining stored data even when being energized. The memory device 20 may store data through a write operation and output data stored in the memory device 20 through a read operation. The memory device 20 may include a plurality of memory blocks, and each of the memory blocks may include a plurality of pages. Each of the pages may include a plurality of memory cells connected to one word line. The memory cell may be a multi-level cell (MLC) storing a plurality of bits.

The memory device 20 may perform erase, write or read operations under the control of the memory controller 10. To this end, the memory device 20 may receive a command signal (CMD) and an address signal (ADDR) from the memory controller 10 through an input/output line, and transceiver data (DATA) for the write operation or the read operation to and from the memory controller 10. The memory device 20 may receive a control signal (CTRL) through a control line. In addition, the memory device 20 may receive power (PWR) from the memory controller 10.

The memory controller 10 may include a data converter (DCON) 12 for controlling a method of controlling an operation of the memory device 20. The data converter 12 may perform state shaping and an error correction code (ECC) operation for the data.

The state shaping may be an operation to selectively remove or reduce some of a plurality of write states stored in a multi-level cell of the memory device 20. A threshold voltage distribution occupied by a specific write state may be reduced by state shaping, and the number of voltages required for write and read operations may be reduced. Accordingly, a deterioration of the multi-level cell may be reduced, thereby extending the life of the memory device 20.

The ECC operation may be an operation to detect and correct errors in the data stored in the memory device 20. An error such as bit flip that may occur during the write and read operations may be detected and corrected by the ECC operation, thereby improving the reliability of the data.

A general data converter may first perform state shaping on input data, and then perform ECC encoding. ECC parity bits generated by ECC encoding may not be state-shaped. That is, since ECC encoding is performed after state shaping, specific write states of the ECC parity bits may not be completely removed. Therefore, among the plurality of write states stored in the multi-level cells of the memory device, a specific write state may not be completely removed or reduced.

The data converter 12 may generate write data by simultaneously performing state shaping and ECC encoding. The write data may be provided to the memory device 20 and thereby. As an example, the data converter 12 may simultaneously perform state shaping and ECC encoding for each of the plurality of pages so that a specific write state among the write states of pages including the plurality of multi-level cells may be converted into another write state.

In addition, the data converter 12 may receive read data read from the memory device 20. The data converter 12 may perform state deshaping and ECC decoding on the read data to generate data with corrected errors.

In some implementations, state shaping and ECC encoding for data bits and ECC parity bits may be simultaneously performed In addition, state shaping and ECC encoding may be performed simultaneously for each of the plurality of pages so that a specific write state among the plurality of write states may be converted to another write state. Therefore, an efficiency of state shaping of the memory device 20 may be improved, so that the life of the memory device 20 may be improved.

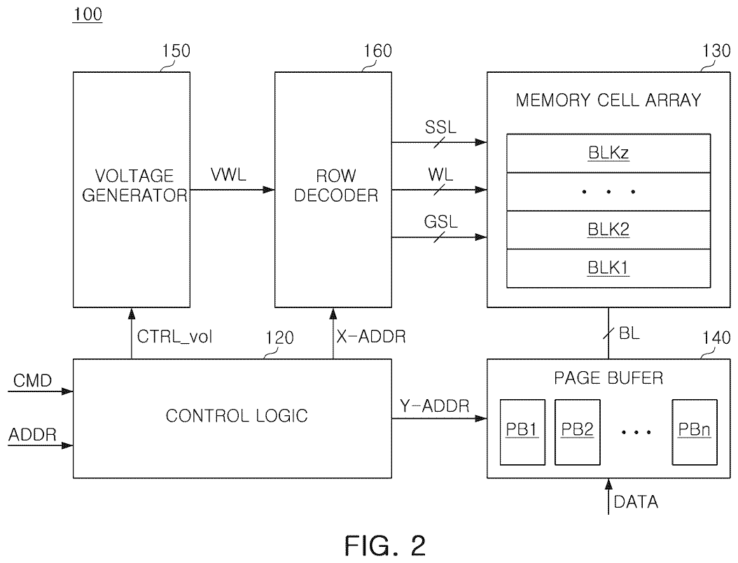

FIG. 2 is a block diagram schematically illustrating an example of a memory device.

Referring to FIG. 2, a memory device 100 may include a control logic circuit 120, a memory cell array 130, a page buffer 140, a voltage generator 150, and a row decoder 160. Although not shown in FIG. 2, the memory device 100 may further include a memory interface circuit receiving a command signal CMD and an address signal ADDR externally and exchanging data DATA externally, and also may further include a column logic, a pre-decoder, a temperature sensor, a command decoder, an address decoder, and the like.

The control logic circuit 120 may generally control various operations in the memory device 100. The control logic circuit 120 may output various control signals in response to a command signal CMD and/or an address signal ADDR from the memory interface circuit. For example, the control logic circuit 120 may output a voltage control signal CTRL_vol, a row address X-ADDR, and a column address Y-ADDR.

The memory cell array 130 may include a plurality of memory blocks BLK1 to BLKz (where z is a positive integer), and each of the plurality of memory blocks BLK1 to BLKz may include a plurality of memory cells. The memory cell array 130 may be connected to the page buffer 140 through bit lines BL, and may be connected to the row decoder 160 through word lines WL, string select lines SSL, and ground select lines GSL.

In some implementations, the memory cell array 130 may include a three-dimensional memory cell array, and the three-dimensional memory cell array may include a plurality of NAND strings. Each of the NAND strings may include memory cells respectively connected to word lines vertically stacked on a substrate. In some implementations, the memory cell array 130 may include a two-dimensional memory cell array, and the two-dimensional memory cell array may include a plurality of NAND strings arranged in row and column directions.

The page buffer 140 may include a plurality of page buffers PB1 to PBn (where n is an integer greater than or equal to 3), and the plurality of page buffers PB1 to PBn may be respectively connected to memory cells through a plurality of bit lines BL. The page buffer 140 may select at least one bit line among the bit lines BL in response to the column address Y-ADDR. The page buffer 140 may operate as a write driver or a sense amplifier according to an operation mode. For example, during a write operation, the page buffer 140 may apply a bit line voltage corresponding to data to be written to a selected bit line. During a read operation, the page buffer 140 may sense data stored in the memory cell by sensing a current or a voltage of the selected bit line.

The voltage generator 150 may generate various types of voltages for performing write, read, and erase operations, based on the voltage control signal CTRL_vol. For example, the voltage generator 150 may generate a write voltage, a read voltage, a write verification voltage, an erase voltage, or the like, as a word line voltage VWL.

The row decoder 160 may select one of the plurality of word lines WL in response to the row address X-ADDR, and may select one of the plurality of string select lines SSL. For example, the row decoder 160 may apply a write voltage and a write verification voltage to a selected word line during the write operation. The row decoder 160 may apply a read voltage to the selected word line during the read operation.

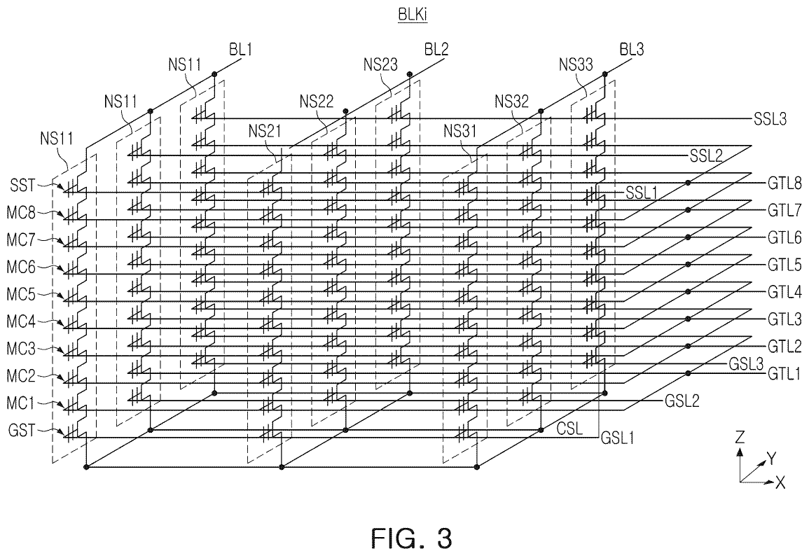

FIG. 3 is a diagram illustrating an example of a 3D V-NAND structure that may be applied to a memory system.

When a memory device of a storage device is implemented as a 3D V-NAND type flash memory, a plurality of memory blocks constituting the memory device may be respectively represented by an equivalent circuit as illustrated in FIG. 3.

Referring to FIG. 3, the memory block BLKi may include a plurality of memory NAND strings NS11 to NS33 connected between bit lines BL1 to BL3 and a common source line CSL. Each of the plurality of memory NAND strings NS11 to NS33 may include a string select transistor SST, a plurality of memory cells MC1 to MC8, and a ground select transistor GST. Although each of the plurality of memory NAND strings NS11 to NS33 is illustrated as including eight memory cells MC1 to MC8 in FIG. 3, the present disclosure is not necessarily limited thereto.

The string select transistor SST may be connected to string select lines SSL1 to SSL3 corresponding thereto. The plurality of memory cells MC1 to MC8 may be respectively connected to gate lines GTL1 to GTL8 corresponding thereto. The gate lines GTL1 to GTL8 may correspond to word lines, and a portion of the gate lines GTL1 to GTL8 may correspond to dummy word lines. The ground select transistor GST may be connected to ground select lines GSL1 to GSL3 corresponding thereto. The string select transistor SST may be connected to the bit lines BL1 to BL3 corresponding thereto, and the ground select transistor GST may be connected to the common source line CSL.

Word lines having the same height (e.g., WL1) may be commonly connected, and the ground selection lines GSL1 to GSL3 and the string select lines SSL1 to SSL3 may be separated from each other. In FIG. 3, the memory block BLK is illustrated as being connected to eight gate lines GTL1 to GTL8 and three bit lines BL1 to BL3, but the present disclosure is not necessarily limited thereto.

The memory block BLKi may include a plurality of pages. For example, a single page may include at least one of a plurality of memory cells MC1 to MC8 connected to one of the gate lines GTL1 to GTL8. For example, if each of the plurality of memory cells MC1 to MC8 is a TLC capable of storing 3 bits of data, each bit of the 3 bits of data may be stored in a different page.

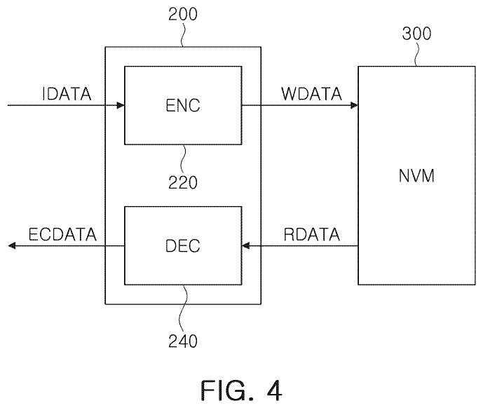

FIG. 4 is a block diagram schematically illustrating an example of a data converter and a memory device.

First, referring to FIG. 4, the data converter 200 may include an encoding unit (ENC) 220 and a decoding unit (DEC) 240. The encoding unit 220 may receive input data IDATA and perform state shaping and ECC encoding on the input data IDATA to generate write data WDATA. The write data WDATA may be provided to a memory device 300 and written. The decoding unit 240 may receive read data RDATA read from the memory device 300 and perform state deshaping and ECC decoding on the read data RDATA to generate error-corrected data ECDATA.

The decoding unit 240 may operate in conjunction with the encoding unit 220. To this end, the decoding unit 240 may share operation information used in the encoding unit 220. As an implementation shown in FIG. 4, each of the encoding unit 220 and the decoding unit 240 may include separate components, thereby being differentiated from each other. In some implementations, the encoding unit 220 and the decoding unit 240 may share some components.

In some implementations, the encoding unit 220 may perform state shaping and ECC encoding simultaneously using an overall generation matrix. In some implementations, the encoding unit 220 may independently perform state shaping and ECC encoding in units of pages of the memory device 300. The overall generation matrix may be a matrix for an arbitrary error correction code. As an example, the overall generation matrix may be a matrix used to encode data in a low-density parity-check (LDPC), but the present disclosure may not be limited thereto. The overall generation matrix may serve as generating a codeword by combining data bits with a parity bit.

Some columns of the overall generation matrix may be divided into a temporary error correction generation matrix, and the remaining columns of the overall generation matrix may be divided into a shaping generation matrix. Bits of the input data IDATA may be converted into a column vector, and the column vector may be a temporary error correction message vector. The temporary error correction message vector may be converted into a temporary codeword through the temporary error correction generation matrix.

A column vector including a bit value inverting at least one of the bit values of the temporary codeword may be produced, and the column vector may be an additional codeword. A shaping parity vector may be produced from the shaping generation matrix and the additional codeword. In other words, the shaping parity vector may be produced based on the temporary codeword of a single page.

An overall message vector may be generated by performing an XOR operation on the temporary error correction message vector and the shaping parity vector. The overall message vector may be converted into an overall codeword through the overall generation matrix. The overall codeword may be the write data WDATA provided to the memory device 300.

In some implementations, the shaping parity vector may be produced based on write states of a plurality of pages. In some implementations, the encoding unit 220 may produce a temporary codeword for each of the plurality of pages. A plurality of write states may be derived from the temporary codeword. The encoding unit 220 may produce a column vector for each of the plurality of pages for converting at least one of the plurality of write states into another write state as an additional codeword. In each of the plurality of pages, the additional codeword may be generated as an overall codeword through the steps described above.

The decoding unit 240 may restore the converted write state included in the read data RDATA to the original write state and correct the error. In other words, state deshaping and ECC decoding may be performed simultaneously, so that the decoding unit 240 may generate the error-corrected data ECDATA from the read data RDATA.

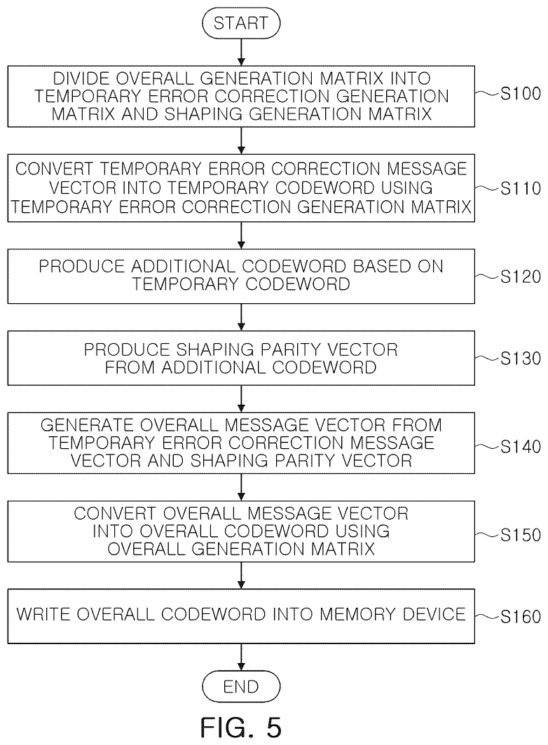

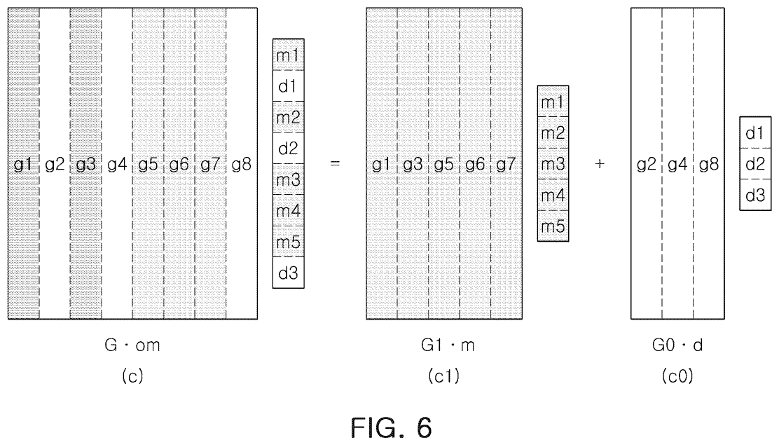

Hereinafter, the operation control process for generating a shaping parity vector based on a temporary codeword of a single page by the encoding unit 220 will be described in detail with reference to FIGS. 5 and 6.

FIG. 5 is a flow diagram illustrating an example of a process of controlling an operation of a memory device. FIG. 6 is a diagram provided to explain an example of an overall generation matrix.

A memory system may include a memory controller and at least one memory device, and the memory device may be a nonvolatile memory device. The memory controller may include an encoding unit and a decoding unit, and may control an erase, write or read operations of the memory device. The memory controller may perform state shaping and ECC operations simultaneously. Specific implementations of the memory system may be similar to those described above with reference to FIGS. 1 to 4.

First, referring to FIGS. 5 and 6 together, the encoding unit may divide the overall generation matrix G into a temporary error correction generation matrix G1 and a shaping generation matrix G0 (S100). In some implementations, some columns of the overall generation matrix G may be divided into a temporary error correction generation matrix G1, and the remaining columns of the overall generation matrix G may be divided into a shaping generation matrix G0. As an example, the overall generation matrix G of size n×k may be split into a temporary error correction generation matrix G1 of size n×k1 and a shaping generation matrix G0 of size n×k2. In this case, the sum of k1 and k2 may be equal to k, and n and k may be the same or different.

In some implementations illustrated in FIG. 6, the overall generation matrix G may include a plurality of column vectors. For example, the overall generation matrix G may include eight column vectors g1 to g8, as shown in FIG. 6. The first, third and fifth to seventh column vectors g1, g3, g5, g6 and g7 of the overall generation matrix G may be divided into the temporary error correction generation matrix G1. The second, fourth and eighth column vectors g2, g4 and g8 of the overall generation matrix G may be divided into the shaping generation matrix G0. However, the number and division of the column vectors of the overall generation matrix G may not be limited thereto.

In the overall generation matrix G of an implementation, at least one column of the shaping generation matrix G0 may be arranged between the columns of the temporary error correction generation matrix G1. In the overall generation matrix G, the shaping generation matrix G0 and the temporary error correction generation matrix G1 may not be separated by a single boundary in the overall generation matrix G. In other words, some of the columns g2, g4 and g8 of the shaping generation matrix G0 may be mixed between the columns g1, g3, g5, g6 and g7 of the temporary error correction generation matrix G1.

The encoding unit may convert a temporary error correction message vector m into a temporary codeword c1 using the temporary error correction generation matrix G1 (S110). The temporary error correction message vector m may be a column vector obtained by converting bits of input data. The number of columns of the temporary error correction generation matrix G1 may be the same as the number of bits of the temporary error correction message vector m. The temporary codeword c1 may be a product of the temporary error correction generation matrix G1 and the temporary error correction message vector m. The size of the temporary codeword c1 may be n×1, as a product of the temporary error correction generation matrix G1 of size n×k1 and the temporary error correction message vector m of size k1×1. The temporary codeword c1 may include ECC parity bits generated by encoding only the input data.

The encoding unit may produce an additional codeword c0 based on the temporary codeword c1 (S120). In some implementations, the additional codeword c0 may include a bit inverting at least one of the bit values of the temporary codeword c1. The temporary codeword c1 and the additional codeword c0 may be added. As an example, in order to invert all the bits of 1 of the temporary codeword c1, the corresponding position of the additional codeword c0 may include a bit of 1, and the remaining positions may include a bit of 0. The additional codeword c0 may be a column vector of the bits of 1 and 0. The additional codeword c0 is a column vector that shapes bits at a specific position of the temporary codeword c1, and may be a vector that encodes only shaping parity bits.

The encoding unit may produce a shaping parity vector d from the additional codeword c0 (S130). In some implementations, the additional codeword c0 may be a product of the shaping generation matrix G0 and the shaping parity vector d. Therefore, the shaping parity vector d may be produced as a product of the inverse matrix of the shaping generation matrix G0 and the additional codeword c0. As a product of the inverse matrix of the shaping generation matrix G0 of size k2×n and the additional codeword (c0) of size n×1, the size of the shaping parity vector d may be k2×1. The shaping parity vector d may be a column vector of the shaping parity bits.

The number of columns of the shaping generation matrix G0 may be equal to the number of bits of the shaping parity vector d. The shaping parity vector d may be a column vector of the bits.

The encoding unit may generate an overall message vector om from the temporary error correction message vector m and the shaping parity vector d (S140). In some implementations, the encoding unit may generate the overall message vector om by performing an XOR operation on the temporary error correction message vector m and the shaping parity vector d.

In the implementation illustrated in FIG. 6, the temporary error correction message vector m and the shaping parity vector d of the overall message vector om may be rearranged according to the arrangement of the columns g of the temporary error correction generation matrix G1 of the overall generation matrix G and the shaping generation matrix G0. According to the column arrangement of the overall generation matrix G, the overall message vector om may be a column vector including bits arranged in the order of m1, d1, m2, d2, m3, m4, m5 and d3.

The encoding unit may convert the overall message vector om into the overall codeword c using the overall generation matrix G (S150). In the implementation illustrated in FIG. 6, the number of columns of the overall generation matrix G may be equal to the number of bits of the overall message vector om. The overall codeword c may be a product of the overall generation matrix G and the overall message vector om. As a product of the overall generation matrix G of size n×k and the overall message vector om of size k×1, the overall codeword c may be a column vector of size n×1.

The encoding unit may transmit the overall codeword c to the memory device to write the overall codeword c (S160). Referring to FIG. 4 together, the overall codeword c corresponds to write data WDATA, and therefore may correspond to an object of the write operation.

Through the processes from S100 to S150 above, the encoding unit may perform the state shaping and the ECC encoding on the input data simultaneously using the overall generation matrix G. In some implementations, the columns g of the overall generation matrix G may be randomly divided, and each of the resulting matrices may be used to produce the temporary codeword c1 and the shaping parity vector d, respectively. Accordingly, the performance of the state shaping may be improved, and the bits of the temporary codeword c1 may be efficiently controlled.

In some implementations, the division of the temporary error correction generation matrix G1 and the shaping generation matrix G0 may be controlled based on previously executed simulation result data. Before operation S100 is performed, the memory controller may produce shaping parity vectors d for various combinations of division cases of the overall generation matrix G and various temporary error correction message vectors m. The memory controller may produce and store statistical data on whether the shaping parity vector d may be produced and the number of bits that are inverted among the temporary error correction message vectors m. The encoding unit may determine the temporary error correction generation matrix G1 and the shaping generation matrix G0 based on the statistical data and perform operations S100 to S160.

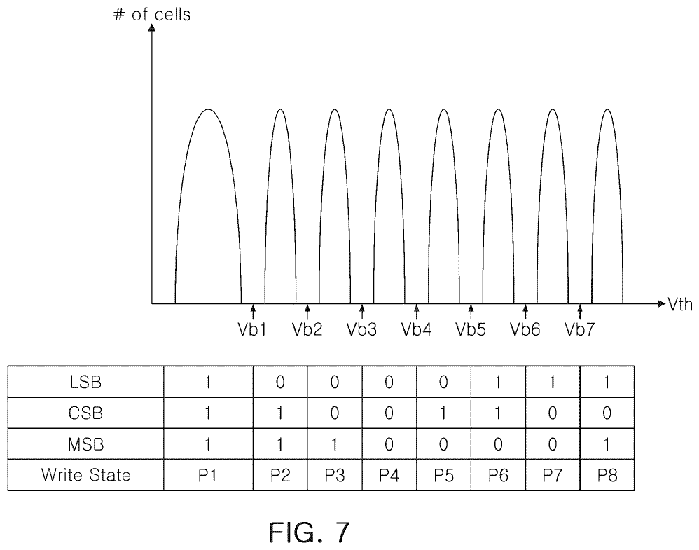

FIG. 7 is a diagram illustrating example write states of a multi-level cell to which a method of controlling an operation of a memory device may be applied.

Referring to FIG. 7, a horizontal axis may represent a size of a threshold voltage Vth, and a vertical axis may represent the number of memory cells corresponding to the threshold voltage.

As the implementation illustrated in FIG. 7, the memory cell may correspond to a triple level cell (TLC) storing 3 bits of data, but the number of bits of data that the memory cell may store may not be limited thereto. When the memory cell is a TLC, the memory cell may have a threshold voltage corresponding to one of the first to eighth write states P1 to P8.

A set of read voltages for distinguishing each of the first to eighth write states P1 to P8 may include first to seventh read voltages Vb1 to Vb7. The write execution results for the first to eighth write states P1 to P8 may be determined by sequentially applying the first to seventh read voltages Vb1 to Vb7 to the selected word line.

The first read voltage Vb1 may be a read voltage for distinguishing the first write state P1 and the second write state P2. The second read voltage Vb2 may be a read voltage for distinguishing between the second write state P2 and the third write state P3. The third read voltage Vb3 may be a read voltage for distinguishing between the third write state P3 and the fourth write state P4.

The fourth read voltage Vb4 may be a read voltage for distinguishing between the fourth write state P4 and the fifth write state P5. The fifth read voltage Vb5 may be a read voltage for distinguishing between the fifth write state P5 and the sixth write state P6. The sixth read voltage Vb6 may be a read voltage for distinguishing between the sixth write state P6 and the seventh write state P7. The seventh read voltage Vb7 may be a read voltage for distinguishing between the seventh write state P7 and the eighth write state P8.

Referring to FIG. 7, a least significant bit LSB, a center significant bit CSB, and a most significant bit MSB may be written in the memory cell. In some implementations, LSB, CSB and MSB may be written in different pages, and the different pages may correspond to pages connected to the same word line.

The write state of each memory cell may be determined according to the values of LSB, CSB and MSB written to the memory cell. The memory cell into which LSB, CSB and MSB are written may have one of the first to eighth write states P1 to P8.

In some implementations illustrated in FIG. 7, the memory cell into which LSB is written as ‘1,’ CSB is written as ‘1’ and MSB is written as ‘1’ may have a first write state P1. The memory cells of the first state P1 may have the lowest threshold voltage distribution range among the first to eighth write states P1 to P8.

The memory cell in which LSB is written as ‘0,’ CSB is written as ‘1’ and MSB is written as ‘1’ may have a second write state P2. The memory cells of the second write state P2 may have a threshold voltage distribution range at a higher level than the threshold voltage distribution range of the memory cells of the first write state P1.

The memory cell in which LSB is written as ‘0,’ CSB is written as ‘0,’ and MSB is written as ‘1’ may have a third write state P3. The memory cells of the third write state P3 may have a threshold voltage distribution range at a higher level than the threshold voltage distribution range of the memory cells of the second write state P2.

The memory cell in which LSB is written as ‘0,’ CSB is written as ‘0,’ and MSB is written as ‘0’ may have a fourth write state P4. The memory cells in the fourth write state P4 may have a threshold voltage distribution range that is higher than the threshold voltage distribution range of the memory cells in the third write state P3.

The memory cell in which LSB is written as ‘0,’ CSB is written as ‘1,’ and MSB is written as ‘0’ may have a fifth write state P5. The memory cells in the fifth write state P5 may have a threshold voltage distribution range that is higher than the threshold voltage distribution range of the memory cells in the fourth write state P4.

The memory cell in which LSB is written as ‘1,’ CSB is written as ‘1,’ and MSB is written as ‘0’ may have a sixth write state P6. The memory cells of the sixth write state P6 may have a threshold voltage distribution range at a higher level than the threshold voltage distribution range of the memory cells of the fifth write state P5.

The memory cell in which LSB is written as ‘1,’ CSB is written as ‘0,’ and MSB is written as ‘0’ may have a seventh write state P7. The memory cells of the seventh write state P7 may have a threshold voltage distribution range at a higher level than the threshold voltage distribution range of the memory cells of the sixth write state P6.

The memory cell in which LSB is written as ‘1,’ CSB is written as ‘0,’ and MSB is written as ‘1’ may have an eighth write state P8. The memory cells of the eighth write state P8 may have a threshold voltage distribution range at a higher level than the threshold voltage distribution range of the memory cells of the seventh write state P7.

The memory cells of the eighth write state P8 may have the highest threshold voltage distribution range among the first to eighth write states P1 to P8. In order to write the eighth write state P8, the highest write voltage may be applied to the word line. When writing the eighth write state P8, the deterioration of the memory cells connected to the same word line may occur the most. In other words, the eighth write state P8 having the highest threshold voltage distribution may correspond to an object write state to be removed through state shaping. However, it may not be limited thereto.

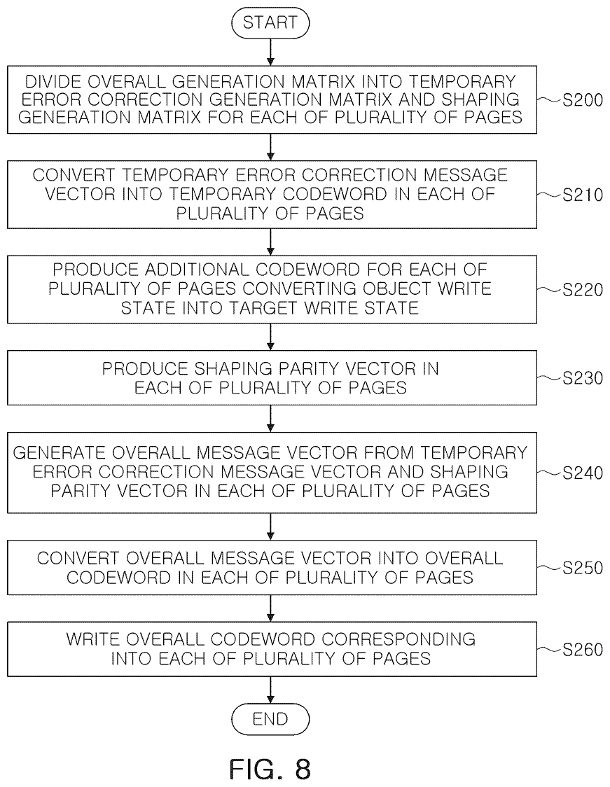

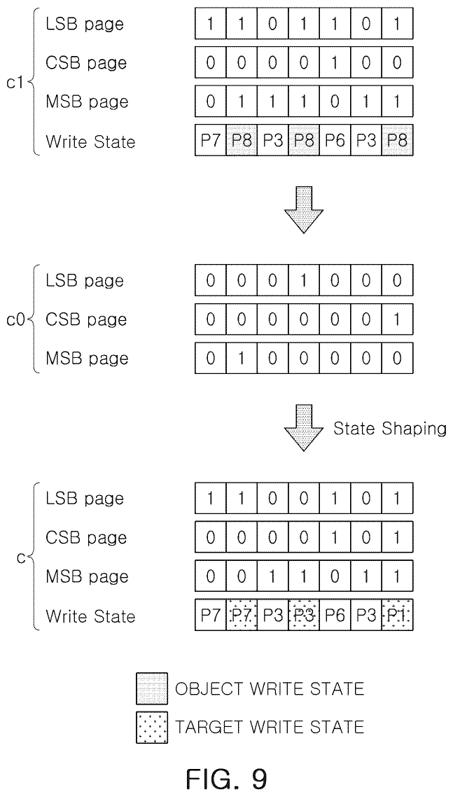

Hereinafter, an operation control process in which an encoding unit process a shaping parity vector based on write states of multiple pages will be described in detail with reference to FIGS. 8 and 9.

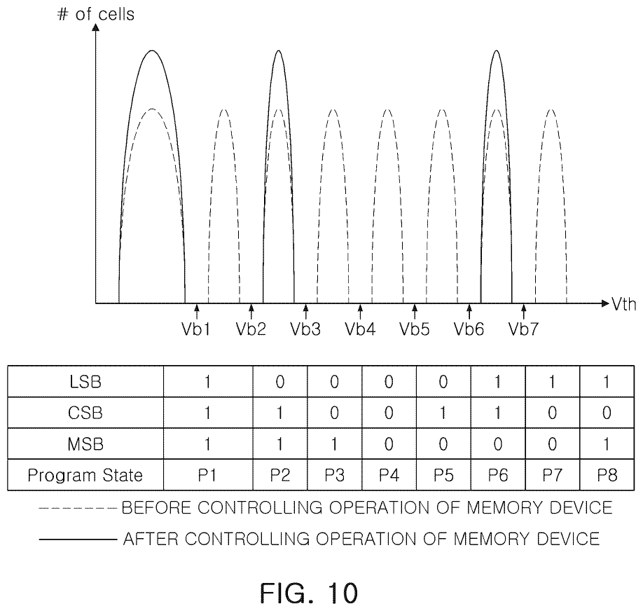

FIG. 8 is a flow diagram illustrating an example of a process of controlling an operation of a memory device. FIG. 9 is a diagram provided to explain an example of an overall generation matrix. FIG. 10 is a diagram illustrating example write states of a multi-level cell to which a method of controlling an operation of a memory device may be applied.

A memory system may include a memory controller and at least one memory device, and the memory device may be a nonvolatile memory device. The memory controller may include an encoding unit and a decoding unit, and may control an erase, write or read operations of the memory device. The memory controller may perform state shaping and ECC operations simultaneously.

Each of the memory blocks may include a plurality of pages. One page may include a plurality of memory cells connected to one word line. The memory cell may be a multi-level cell storing a plurality of bits. In some implementations, the memory cell may be a TLC capable of storing 3 bits of data. The 3 bits may be LSB, CSB and MSB, and each bit may be stored in a different page.

Hereinafter, the plurality of pages may include an LSB page storing LSB, a CSB page storing CSB, and an MSB page storing MSB. Specific implementations of the memory system may be similar to those described above with reference to FIGS. 1 to 7.

First, referring to FIG. 8 together, one overall generation matrix G may be applied equally to the plurality of pages. The encoding unit may divide the overall generation matrix G into a temporary error correction generation matrix G1 and a shaping generation matrix G0 for each of the plurality of pages (S200). In other words, the same temporary error correction generation matrix G1 and shaping generation matrix G0 may be applied to all of LSB page, CSB page and MSB page, or a different temporary error correction generation matrix G1 and a different shaping generation matrix G0 may be applied to at least one page. Specific implementations may be similar to those described above with reference to operation S100 of FIG. 5.

In each of the plurality of pages, the encoding unit may convert a temporary error correction message vector m into a temporary codeword c1 (S210). Specifically, in each of the plurality of pages, the encoding unit may convert the temporary error correction message vector m into the temporary codeword c1 using the temporary error correction generation matrix G1. In each of the plurality of pages, the temporary codeword c1 may be a product of the temporary error correction generation matrix G1 and the temporary error correction message vector m.

Referring to FIG. 9, the temporary codeword c1 of LSB page may be represented as ‘1101101.’ The temporary codeword c1 of CSB page may be represented as ‘0000100.’ The temporary codeword c1 of MSB page may be represented as ‘0111011.’ Accordingly, the write states of each of the multi-level cells may be P7, P8, P3, P8, P6, P3 and P8. Specific examples of write states may be similar to those described above in FIG. 7.

The encoding unit may generate an additional codeword for each of the plurality of pages that converts an object write state into a target write state (S220). In the implementation illustrated in FIG. 9, the object write state may be the eighth write state P8 having the highest threshold voltage distribution range.

Unlike in FIG. 9, the object write states may be two or more write states. As an example, the first and eighth write states P1 and P8 may be the target write states.

In some implementations, the encoding unit may select the target write state for each object write state. The target write state may include at least one of the remaining write states excluding the object write state among the plurality of write states. As an example, the target write state may be a state in which at least one of the bit values of the plurality of pages of the object write state is inverted.

In the implementation illustrated in FIG. 9, the target write states for the three object write states P8 may be different from each other. The target write states for each of the three object write states P8 may be the first, third and seventh write states P1, P3 and P7. In other words, each of the target write states may be a state in which at least one bit value among multiple pages of the target write state is inverted.

Referring to FIG. 9, the eighth write state P8 may be converted into the third write state P3 by inverting the bit stored in LSB page of the eighth write state P8. The eighth write state P8 may be converted into the first write state P1 by inverting the bit stored in CSB page of the eighth write state P8. The eighth write state P8 may be converted into the seventh write state P7 by inverting the bit stored in MSB page of the eighth write state P8.

The additional codeword c0 may be calculated by synthesizing the bit inversions of the multiple pages. According to the implementation illustrated in FIG. 9, the additional codeword c0 of LSB page may correspond to ‘0001000.’ The additional codeword c0 of CSB page may correspond to ‘0000001.’ The additional codeword c0 of MSB page may correspond to ‘0100000.’

Unlike that illustrated in FIG. 9, the target write state for the plurality of object write states may be one. For example, the target write state for the three object write states P8 may be one of the first to seventh write states P1 and P7. In this case, the bits and the additional codeword c0 that are inverted in the plurality of pages may be calculated according to the target write state.

As another example, the target write state for at least one of the plurality of object write states may be different. For example, the target write state for one of the three object write states P8 may be the third write state P3, and the target write states for the remaining two may be the fourth write state P4. When the target write state is the third write state P3, bits may be inverted in LSB page of one target write state P8. When the target write state is the fourth write state P4, bits may be inverted in LSB page and MSB page of each of the two target write states P8.

As another example, the object write states may include the first and second object write states. For example, the first object write state may be the first write state P1, and the second target write state may be the eighth write state P8. In this case, the target write states of each of the first and second object write states may be at least one of the second to seventh write states P2 to P7. As an example, the target write states of the first and second object write states may be the same write state. In another example, the target write states of the first and second object write states may be different write states.

However, specific examples, such as the number and types of each of the object write states and the target write states, may not be limited thereto.

In each of the plurality of pages, the encoding unit may generate a shaping parity vector d from the additional codeword c0 (S230). The additional codeword c0 may be a product of the shaping generation matrix G0 and the shaping parity vector d. Therefore, the shaping parity vector d may be generated as a product of an inverse matrix of the shaping generation matrix G0 and the additional codeword c0.

In each of the plurality of pages, the encoding unit may generate an overall message vector om from the temporary error correction message vector m and a shaping parity vector d (S240). In some implementations, the encoding unit may generate the overall message vector om by performing an XOR operation on the temporary error correction message vector m and the shaping parity vector d. In each of the plurality of pages, the temporary error correction message vector m and the shaping parity vector d of the overall message vector om may be rearranged according to the arrangement of the columns g of the temporary error correction generation matrix G1 and the shaping generation matrix G0 of the overall generation matrix G.

In each of the plurality of pages, the encoding unit may convert the overall message vector om into the overall codeword c (S250). The overall codeword c of each of the plurality of pages may be generated by a product of the overall generation matrix G and the corresponding overall message vector om. Referring to FIG. 9, the overall codeword c of LSB page may correspond to ‘1100101.’ The overall codeword c of CSB page may correspond to ‘0000101.’ The overall codeword c of MSB page may correspond to ‘0011011.’

As a result of performing the state shaping and state shaping ECC encoding simultaneously through the processes from S200 to S250 above, the write states of each of the multi-level cells may be P7, P7, P3, P3, P6, P3 and P1. In other words, the eighth write state P8, which is the object write state, may be removed.

Referring to FIG. 10, a horizontal axis may represent a size of a threshold voltage Vth, and a vertical axis may represent the number of memory cells corresponding to the threshold voltage. The graphs illustrated in FIG. 10 may represent write states in which state shaping and ECC encoding are performed according to an implementation illustrated in FIG. 9.

Referring to FIG. 9 and FIG. 10 together, the three target write states P8 may be converted into different target write states P1, P3 and P7. Accordingly, the number of memory cells having the target write state P8 may decrease, and as an example, there may be no memory cells having the target write state P8. In addition, the number of memory cells having the target write states P1, P3 and P7 may increase.

The encoding unit may transmit the overall codeword c of each of the plurality of pages to the memory device, and may write the overall codeword c corresponding to each of the plurality of pages (S260).

Through the processes from S210 to S250 above, the encoding unit may produce the shaping parity vector d for each of the plurality of pages based on the write states of the plurality of pages. The overall codeword c may be generated by simultaneously performing the state shaping and the ECC encoding for each of the plurality of pages. In this case, the specific implementations of the overall generation matrix G described above in FIGS. 5 and 6 may be applied. Accordingly, the performance of the state shaping may be improved, and the design freedom of the state shaping may be improved.

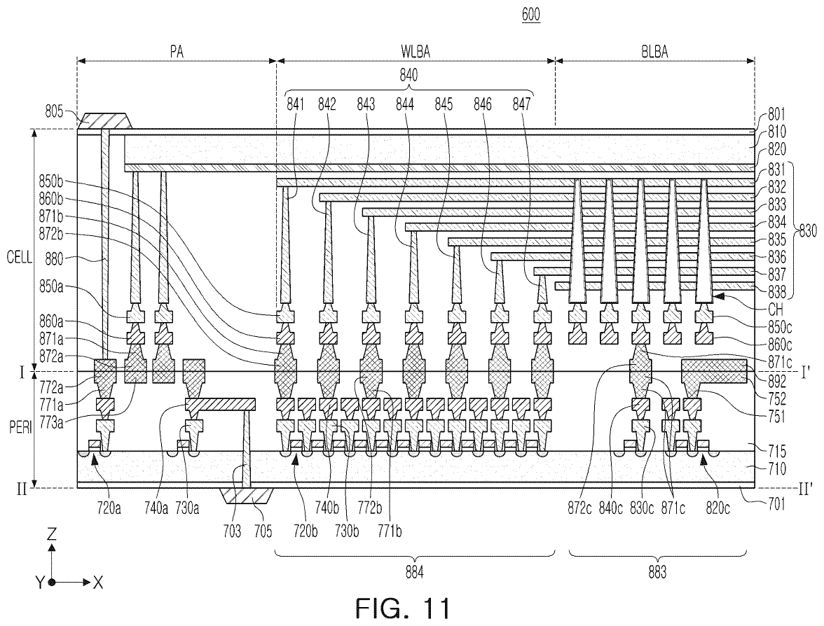

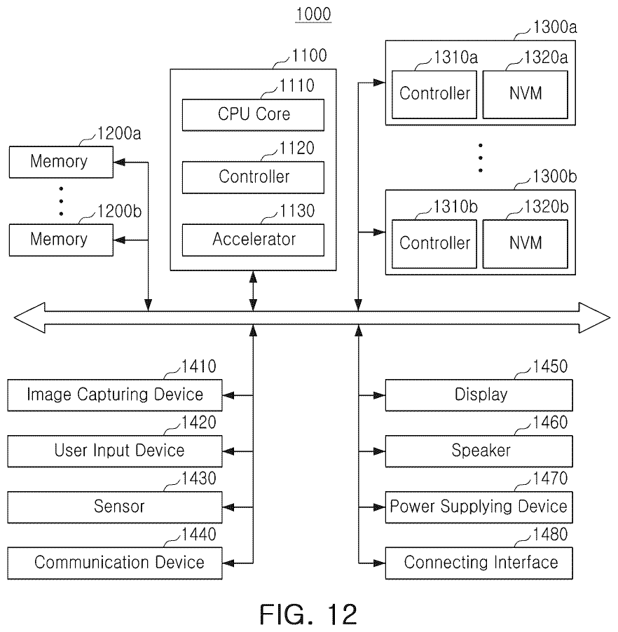

Hereinafter, a structure of a memory device to which the present disclosure may be applied and an implementation of a system to which the present disclosure may be applied will be described with reference to FIGS. 11 and 12.

FIG. 11 is a diagram illustrating an example of a memory device.

Referring to FIG. 11, the memory device 600 may have a chip-to-chip (C2C) structure. The C2C structure may refer to a structure formed by manufacturing an upper chip including a cell region CELL on a first wafer, manufacturing a lower chip including a peripheral circuit region PERI on a second wafer, different from the first wafer, and then bonding the upper chip and the lower chip to each other by a bonding process. For example, the bonding process may refer to a method of electrically connecting a bonding metal formed on an uppermost metal layer of the upper chip and a bonding metal formed on an uppermost metal layer of the lower chip. For example, when the bonding metal is formed of copper (Cu), the bonding method may be a Cu-Cu bonding method, and the bonding metal may also be formed of aluminum or tungsten.

Each of the peripheral circuit region PERI and the cell region CELL of the memory device 600 may include an external pad bonding area PA, a word line bonding area WLBA, and a bit line bonding area BLBA. The peripheral circuit region PERI may include a first substrate 710, an interlayer insulating layer 715, a plurality of circuit elements 720a, 720b and 720c formed on the first substrate 710, a first metal layer 730a, 730b and 730c respectively connected to the plurality of circuit elements 720a, 720b and 720c, and a second metal layer 740a, 740b and 740c formed on the first metal layer 730a, 730b and 730c. In some implementations, the first metal layer 730a, 730b and 730c may be formed of tungsten having relatively high electrical resistivity, and the second metal layer 740a, 740b and 740c may be formed of copper having relatively low electrical resistivity.

In this specification, only the first metal layer 730a, 730b and 730c and the second metal layer 740a, 740b and 740c are illustrated and described, but not limited thereto, and at least one or more metal layers may be further formed on the second metal layer 740a, 740b and 740c. At least a portion of the one or more metal layers formed on the second metal layer 740a, 740b and 740c may be formed of aluminum or the like having a lower resistance than copper forming the second metal layer 740a, 740b and 740c.

The interlayer insulating layer 715 may be disposed on the first substrate 710 to cover the plurality of circuit elements 720a, 720b and 720c, the first metal layer 730a, 730b and 730c, and the second metal layer 740a, 740b and 740c, and may include an insulating material such as silicon oxide, silicon nitride, or the like.

Lower bonding metals 771b and 772b may be formed on the second metal layer 740b in the word line bonding area WLBA. In the word line bonding area WLBA, the lower bonding metals 771b and 772b in the peripheral circuit region PERI may be electrically bonded to upper bonding metals 871b and 872b of the cell region CELL by means of a bonding method. The lower bonding metals 771b and 772b and the upper bonding metals 871b and 872b may be formed of aluminum, copper, tungsten, or the like. The upper bonding metals 871b and 872b of the cell region CELL may be referred to as first metal pads, and the lower bonding metals 771b and 772b of the peripheral circuit region PERI may be referred to as second metal pads.

The cell region CELL may include at least one memory block. The cell region CELL may include a second substrate 810 and a common source line 820. On the second substrate 810, a plurality of word lines 831 to 838 (i.e., 830) may be stacked in a direction (the Z-axis direction), perpendicular to an upper surface of the second substrate 810. String select lines and a ground select line may be arranged on and below the plurality of word lines 830, respectively, and the plurality of word lines 830 may be disposed between the string select lines and the ground select line.

In the bit line bonding area BLBA, a channel structure CH may extend in a direction, perpendicular to the upper surface of the second substrate 810, and may pass through the plurality of word lines 830, the string select lines and the ground select line. The channel structure CH may include a data storage layer, a channel layer, a buried insulating layer, and the like, and the channel layer may be electrically connected to a first metal layer 850c and a second metal layer 860c. For example, the first metal layer 850c may be a bit line contact, and the second metal layer 860c may be a bit line. In some implementations, the bit line may extend in the first direction (the Y-axis direction), parallel to the upper surface of the second substrate 810.

In the implementation illustrated in FIG. 11, an area in which the channel structure CH, the bit line, and the like are disposed may be defined as the bit line bonding area BLBA. In the bit line bonding area BLBA, the bit line may be electrically connected to the circuit elements 720c providing a page buffer 893 in the peripheral circuit region PERI. As an example, the bit line may be connected to upper bonding metals 871c and 872c in the peripheral circuit region PERI, and the upper bonding metals 871c and 872c may be connected to a lower bonding metal 771c and 772c connected to the circuit elements 720c of the page buffer 893.

In the word line bonding area WLBA, the word lines 830 may extend in a second direction (an X-axis direction), parallel to the upper surface of the second substrate 810, and may be connected to a plurality of cell contact plugs 841 to 847 (i.e., 840). The word lines 830 and the cell contact plugs 840 may be connected to each other in pads provided by at least a portion of the plurality of word lines 830 extending in different lengths in the second direction. A first metal layer 850b and a second metal layer 860b may be sequentially connected to an upper portion of the plurality of cell contact plugs 840 connected to the plurality of word lines 830. The cell contact plugs 840 may be connected to the peripheral circuit region PERI by the upper bonding metals 871b and 872b of the cell region CELL and the lower bonding metals 771b and 772b of the peripheral circuit region PERI in the word line bonding area WLBA.

The cell contact plugs 840 may be electrically connected to the circuit elements 720b forming a row decoder 894 in the peripheral circuit region PERI. In some implementations, operating voltages of the circuit elements 720b of the row decoder 894 may be different from those of the circuit elements 720c forming the page buffer 893. As an example, operating voltages of the circuit elements 720c forming the page buffer 893 may be greater than those of the circuit elements 720b forming the row decoder 894.

A common source line contact plug 880 may be disposed in the external pad bonding area PA. The common source line contact plug 880 may be formed of a conductive material such as a metal, a metal compound, polysilicon, or the like, and may be electrically connected to the common source line 820. A first metal layer 850a and a second metal layer 860a may be stacked on an upper portion of the common source line contact plug 880, sequentially. For example, an area in which the common source line contact plug 880, the first metal layer 850a, and the second metal layer 860a are disposed may be defined as the external pad bonding area PA.

Meanwhile, input/output pads 705 and 805 may be disposed in the external pad bonding area PA. Referring to FIG. 11, a lower insulating film 701 covering a lower surface of the first substrate 710 may be formed below the first substrate 710, and a first input/output pad 705 may be formed on the lower insulating film 701. The first input/output pad 705 may be connected to at least one of the plurality of circuit elements 720a, 720b and 720c disposed in the peripheral circuit region PERI through a first input/output contact plug 703, and may be separated from the first substrate 710 by the lower insulating film 701. In addition, a side insulating film may be disposed between the first input/output contact plug 703 and the first substrate 710 to electrically separate the first input/output contact plug 703 and the first substrate 710.

Referring to FIG. 11, an upper insulating film 801 covering the upper surface of the second substrate 810 may be formed on the second substrate 810, and a second input/output pad 805 may be disposed on the upper insulating film 801. The second input/output pad 805 may be connected to at least one of the plurality of circuit elements 720a, 720b and 720c disposed in the peripheral circuit region PERI through a second input/output contact plug 803.

In some implementations, the second substrate 810 and the common source line 820 may not be disposed in a region in which the second input/output contact plug 803 is disposed. Also, the second input/output pad 805 may not overlap the word lines 830 in the third direction (the Z-axis direction). Referring to FIG. 11, the second input/output contact plug 803 may be separated from the second substrate 810 in a direction, parallel to the upper surface of the second substrate 810, and may pass through an interlayer insulating layer 815 of the cell region CELL to be connected to the second input/output pad 805.

In some implementations, the first input/output pad 705 and the second input/output pad 805 may be selectively formed. For example, the memory device 600 may include only the first input/output pad 705 disposed on the first substrate 710, or may include only the second input/output pad 805 disposed on the second substrate 810. Alternatively, the memory device 600 may include both the first input/output pad 705 and the second input/output pad 805.

A metal pattern provided on an uppermost metal layer may be provided as a dummy pattern or the uppermost metal layer may be absent, in each of the external pad bonding area PA and the bit line bonding area BLBA, respectively included in the cell region CELL and the peripheral circuit region PERI.

In the external pad bonding area PA, the memory device 600 may form a lower metal pattern 773a having the same shape as an upper metal pattern 872a of the cell region CELL in the peripheral circuit region PERI in correspondence to the upper metal pattern 872a formed in the uppermost metal layer of the cell region CELL. In the peripheral circuit region PERI, the lower metal pattern 773a formed in the uppermost metal layer of the peripheral circuit region PERI may not be connected to a separate contact. Similarly, in the external pad bonding area PA, the memory device 600 may form an upper metal pattern having the same shape as the lower metal pattern of the peripheral circuit region PERI in the upper metal layer of the cell region CELL in correspondence to the lower metal pattern formed on in the uppermost metal layer of the peripheral circuit region PERI.

The lower bonding metals 771b and 772b may be formed on the second metal layer 740b in the word line bonding area WLBA. In the word line bonding area WLBA, the lower bonding metals 771b and 772b of the peripheral circuit region PERI may be electrically connected to the upper bonding metals 871b and 872b of the cell region CELL by bonding.

In addition, in the bit line bonding area BLBA, an upper metal pattern 892 having the same shape as a lower metal pattern 752 of the peripheral circuit region PERI may be formed in the uppermost metal layer of the cell region CELL in correspondence to the lower metal pattern 752 formed in the uppermost metal layer of the peripheral circuit region PERI. A contact may not be formed on the upper metal pattern 892 formed in the uppermost metal layer of the cell region CELL.

As an example, a reinforced metal pattern having the same cross-sectional shape as a metal pattern formed on the uppermost metal layer of one of the cell region CELL and the peripheral circuit region PERI may be formed in correspondence to the metal pattern formed on the uppermost metal layer of the other one of the cell region CELL and the peripheral circuit region PERI. A contact may not be formed in the reinforced metal pattern.

According to an implementation, a memory system may include a memory controller and a memory device 600. The memory controller may include an encoding unit and a decoding unit. The memory device 600 may include a plurality of memory blocks storing data. In some implementations, the encoding unit may divide columns of an overall generation matrix and state shape ECC parity bits as well. In some implementations, the encoding unit may simultaneously state shape and ECC encode each of a plurality of pages based on write states of the plurality of pages. Accordingly, the efficiency of the state shaping may be improved.

FIG. 12 is a diagram illustrating an example of a system to which a storage device is applied.

The system 1000 of FIG. 12 may be basically a mobile system, such as a mobile phone, a smartphone, a tablet personal computer (PC), a wearable device, a healthcare device, or an internet-of-things (IOT) device. However, the system 1000 of FIG. 12 is not necessarily limited to the mobile system, and may be a personal computer, a laptop computer, a server, a media player, an automotive device such as a navigation system, or the like.

Referring to FIG. 12, the system 1000 may include a main processor 1100, memories 1200a and 1200b, and memory systems 1300a and 1300b, and may further include at least one of an image capturing device 1410, a user input device 1420, a sensor 1430, a communication device 1440, a display 1450, a speaker 1460, a power supplying device 1470, or a connecting interface 1480.

The main processor 1100 may control overall operations of the system 1000, and more specifically, operations of other components constituting the system 1000. The main processor 1100 may be implemented as a general-purpose processor, a dedicated processor, an application processor, or the like.

The main processor 1100 may include at least one CPU core 1110, and may further include a controller 1120 for controlling the memories 1200a and 1200b and/or the memory systems 1300a and 1300b. In some implementations, the main processor 1100 may further include an accelerator 1130 that may be a dedicated circuit for high-speed data operation such as artificial intelligence (AI) data operation or the like. The accelerator 1130 may include a graphics processing unit (GPU), a neural processing unit (NPU), and/or a data processing unit (DPU), or the like, and may be implemented as a separate chip, physically independent from other components of the main processor 1100.

The memories 1200a and 1200b may be used as a main memory device of the system 1000, and may include volatile memories such as SRAM and/or DRAM, or the like, but may also include non-volatile memories such as flash memory, PRAM, and/or RRAM, or the like. The memories 1200a and 1200b may be implemented together with the main processor 1100 in the same package.

The memory systems 1300a and 1300b may function as non-volatile memory systems that store data regardless of whether power is supplied or not, and may have a relatively larger storage capacity, as compared to the memories 1200a and 1200b. The memory systems 1300a and 1300b may include storage controllers 1310a and 1310b, and non-volatile memories (NVM) 1320a and 1320b for storing data under control of the storage controllers 1310a and 1310b. The non-volatile memories 1320a and 1320b may include a flash memory having a 2D (2-dimensional) structure or a 3D (3-dimensional) vertical NAND (V-NAND) structure, but may include other types of non-volatile memory such as PRAM and/or RRAM, or the like.

The memory systems 1300a and 1300b may be physically separated from the main processor 1100, or may be implemented together with the main processor 1100 in the same package. In addition, the memory systems 1300a and 1300b may have a shape such as a solid state device (SSD) or a memory card, to be detachably coupled to other components of the system 1000 through an interface such as a connecting interface 1480 to be described later. Such memory systems 1300a and 1300b may be devices to which standard protocols such as a universal flash storage (UFS), an embedded multi-media card (eMMC), or a non-volatile memory express (NVMe) are applied, but the present disclosure is not necessarily limited thereto.

The memory systems 1300a and 1300b may simultaneously perform state shaping and ECC encoding using an overall generation matrix. In some implementations, the memory systems may randomly divide columns of the overall generation matrix and state shape ECC parity bits as well. In some implementations, an encoding unit may simultaneously state shape and ECC encode each of a plurality of pages based on write states of the plurality of pages. Accordingly, the efficiency of the state shaping may be improved.

The image capturing device 1410 may capture a still image or a moving image, and may be a camera, a camcorder, and/or a webcam, or the like.

The user input device 1420 may receive various types of data of the system 1000, input by a user, and may be a touch pad, a keypad, a keyboard, a mouse, and/or a microphone, or the like.

The sensor 1430 may detect various types of physical quantities that may be acquired from the outside of the system 1000, and may convert the sensed physical quantities into electrical signals. Such a sensor 1430 may be a temperature sensor, a pressure sensor, an illuminance sensor, a position sensor, an acceleration sensor, a biosensor, and/or a gyroscope sensor, or the like.

The communication device 1440 may transceiver signals between other devices outside the system 1000 according to various communication protocols. Such a communication device 1440 may be implemented to include an antenna, a transceiver, and/or a modem, or the like.

The display 1450 and the speaker 1460 may function as output devices that respectively output visual information and auditory information to the user of the system 1000.

The power supplying device 1470 may appropriately convert power supplied from a battery mounted in the system 1000 and/or an external power source, and may supply the converted power to each of the components of the system 1000.

The connecting interface 1480 may provide a connection between the system 1000 and an external device that may be connected to the system 1000, and may exchange data with the system 1000. The connecting interface 1480 may be implemented in various interface methods such as an advanced technology attachment (ATA), a serial ATA (SATA), an external SATA (e-SATA), a small computer small interface (SCSI), a serial attached SCSI (SAS), a peripheral component interconnection (PCI), a PCI express (PCIe), NVMe, IEEE 1394, a universal serial bus (USB), a secure digital (SD) card, a multi-media card (MMC), an eMMC, a UFS, an embedded universal flash storage (eUFS), a compact flash (CF) card interface, or the like.

In some implementations, the columns of the entire generation matrix for an arbitrary error correction code may be randomly divided so that ECC parity bits for input data can also be state-shaped. In addition, state-shaping and ECC-encoding may be performed simultaneously for each of a plurality of pages so that a specific write state among a plurality of write states is converted to another write state according to bit values of the plurality of pages. Therefore, the efficiency of state shaping of a memory device may be improved.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While example implementations have been shown and described above, it will be apparent to those skilled in the art that modifications and variations could be made without departing from the scope of the present disclosure as defined by the appended claims.

What is claimed is:

1. A method of controlling an operation of a memory device, comprising:
dividing an overall generation matrix for an arbitrary error correction code into a temporary error correction generation matrix and a shaping generation matrix;
converting, based on the temporary error correction generation matrix, a temporary error correction message vector into a temporary codeword;
producing an additional codeword, the additional codeword comprising a bit inverting at least one bit value of the temporary codeword;
producing, based on the shaping generation matrix and the additional codeword, a shaping parity vector;
performing an XOR operation on the temporary error correction message vector and the shaping parity vector to generate an overall message vector;
converting the overall message vector into an overall codeword based on the overall generation matrix; and
writing the overall codeword into the memory device.

2. The method of claim 1, wherein the overall generation matrix includes a first plurality of columns and a second plurality of columns, the temporary error correction generation matrix comprises the first plurality of columns of the overall generation matrix, and the shaping generation matrix comprises the second plurality of columns of the overall generation matrix.

3. The method of claim 2, wherein a number of columns of the shaping generation matrix is a same as a number of bits of the shaping parity vector.

4. The method of claim 2, wherein a number of columns of the temporary error correction generation matrix is a same as a number of bits of the temporary error correction message vector.

5. The method of claim 2, wherein a number of columns of the overall generation matrix is a same as a number of bits of the overall message vector.

6. The method of claim 2, wherein in the overall generation matrix, at least one column of the shaping generation matrix is arranged between a plurality of columns of the temporary error correction generation matrix.

7. The method of claim 6, wherein the temporary error correction message vector and the shaping parity vector of the overall message vector are rearranged according to a column arrangement of the temporary error correction generation matrix and the shaping generation matrix of the overall generation matrix.

8. The method of claim 1, wherein the temporary codeword is a product of the temporary error correction generation matrix and the temporary error correction message vector.

9. The method of claim 1, wherein the additional codeword is a product of the shaping generation matrix and the shaping parity vector.

10. The method of claim 1, wherein the overall codeword is a product of the overall generation matrix and the overall message vector.

11. A method of controlling an operation of a memory device, comprising:
dividing, for each page of a plurality of pages, an overall generation matrix into a temporary error correction generation matrix and a shaping generation matrix;
converting, in each page of the plurality of pages, a temporary error correction message vector into a temporary codeword based on the temporary error correction generation matrix;
producing, for each page of the plurality of pages, an additional codeword, at least one object write state among a plurality of write states of the plurality of pages being converted into at least one target write state;
producing, in each page of the plurality of pages, a shaping parity vector based on the shaping generation matrix and the additional codeword;
performing, in each page of the plurality of pages, an XOR operation on the temporary error correction message vector and the shaping parity vector to generate an overall message vector;
converting, in each page of the plurality of pages, the overall message vector into an overall codeword based on the overall generation matrix; and
writing the overall codeword into each page of the plurality of pages.

12. The method of claim 11, wherein the plurality of write states are distinguished by a bit value of each page of the plurality of pages.

13. The method of claim 11, wherein the at least one object write state has a highest threshold voltage distribution range among the plurality of write states.

14. The method of claim 11, wherein the at least one object write state has a lowest threshold voltage distribution range among the plurality of write states.

15. The method of claim 11, wherein the at least one target write state comprises at least one write state of the plurality of write states excluding the at least one object write state.

16. The method of claim 15, wherein the at least one target write state is a state in which at least one bit value of a plurality of pages of the at least one object write state is inverted.

17. The method of claim 16, wherein the additional codeword of each page of the plurality of pages converts two or more of identical object write states into different target write states.

18. The method of claim 15, wherein the at least one object write state comprises a first object write state and a second object write state.

19. The method of claim 15, wherein the temporary error correction generation matrix and the shaping generation matrix of at least one page of the plurality of pages are different from temporary error correction generation matrixes and shaping generation matrixes of other pages of the plurality of pages, respectively.

20. A method of controlling an operation of a memory device, comprising:
dividing a first plurality of columns of an overall generation matrix into a temporary error correction generation matrix and dividing a second plurality of columns of the overall generation matrix into a shaping generation matrix, the first plurality of columns and the second plurality of columns defining the overall generation matrix;
converting a temporary error correction message vector into a temporary codeword based on the temporary error correction generation matrix;
producing an additional codeword, the additional codeword comprising a bit inverting at least one bit value of the temporary codeword;
producing a shaping parity vector based on the shaping generation matrix and the additional codeword;
performing an XOR operation on the temporary error correction message vector and the shaping parity vector to generate an overall message vector; and
converting the overall message vector into an overall codeword based on the overall generation matrix,
wherein at least one column of the shaping generation matrix is arranged between a plurality of columns of the temporary error correction generation matrix, and
wherein the temporary error correction message vector and the shaping parity vector of the overall message vector are rearranged according to a column arrangement of the temporary error correction generation matrix and the shaping generation matrix of the overall generation matrix.
